(19) United States
(12) Patent Application Publication
(10) Pub. No.: US 2011/0160333 A1
(43) Pub. Date: Jun. 30, 2011

(54) ANTIMICROBIAL SURFACE AND SURFACE COATS

(75) Inventor: Ronald Edwin Lisec, Chester, SC (US)

(73) Assignee: Hillcrest Financial Partners, LLC

(21) Appl. No.: 12/857,096

(22) Filed: Aug. 16, 2010

Related U.S. Application Data
(60) Provisional application No. 61/291,801, filed on Dec. 31, 2009.

(51) Int. Cl. C09D 5/16

(52) U.S. Cl. 523/122

(57) ABSTRACT

An antimicrobial surface and surface coating includes an antimicrobial material on the surface of an object. The antimicrobial material includes: a metallic flake; an epoxy resin; an epoxy hardener; and a surfactant. The metallic flake is between 45-80% by weight of the antimicrobial material. The epoxy resin is between 10-25% by weight of the antimicrobial material. The epoxy hardener is between 1-10% by weight of the antimicrobial material. The surfactant is between 5-15% by weight of the antimicrobial material.

### RELATED APPLICATION

This application claims the benefit of provisional application Ser. No. 61/291,801 filed Dec. 31, 2009.

### FIELD OF THE INVENTION

The invention is directed to antimicrobial surfaces and antimicrobial coatings for surfaces, to a process for preparing and applying such antimicrobial surfaces and surface coatings, and to the articles having such antimicrobial surfaces and surface coatings.

### BACKGROUND OF THE INVENTION

Humans are exposed daily to millions of microorganisms such as bacteria, fungi, spores, viruses, etc. These microorganisms include dangerous pathogens such as E. coli, Salmonella spp., Campylobacter spp., Enterococcus spp., and Staphylococcus spp. These microorganisms are found on virtually every surface, such as on foods, in air-conditioning and ventilation systems or even on toothbrushes. Daily dealings with other people and contact with articles which others have used, such as door handles, public transportation railings, light switches or faucets, may result in transmission of microorganisms. Such transmissions are particularly common in public structures and especially in hospitals where there is an increased exposure to this risk.

Over time people have become more aware and, as a result, more concerned with protecting themselves from microbes that cause disease, infection, and the growth of bacteria and mold. Making products with antimicrobial additives helps increase protection from microbes. Products containing antimicrobial additives are currently in abundance on the shelves of stores and in consumers' homes, including soaps, lotions, and air fresheners/disinfectants. Such products are used to clean surfaces that may have microbes on them, which offers some protective benefits, but may not prevent the microbes from returning. In the field of healthcare, medical devices and dental instruments, as well as various surgical implants, are made with antimicrobial additives to protect against the spread of germs and infection. Thus, it has been recognized that chemical substances or the use of physical operations, critically influence the growth process of bacteria. These physical methods may include: heat, cold, radiation, ultrasound, etc. Chemical methods may include: halogens, organic compounds and dyes, toxic gases, metals, etc. Although in the majority of cases chemical and physical methods are extraordinarily effective in destroying microorganisms, they currently only provide a short-term effect, promote the development of resistance and in some circumstances are unsuitable for certain applications, since they lead to the destruction of the surfaces to be protected and may be harmful to human contact.

Metallic materials such as copper, silver, zinc, nickel, etc. exhibit long lasting anti-microbial properties. Compounds of these metals are known for their damaging effect on microorganisms (e.g., silver tableware) but have no toxicity on the human body. Several patents have been issued that, among other things, describe the anti-microbial effects of copper, silver, zinc, nickel, etc. (see, for example U.S. Pat. No. 5,147,686 to Ichimura and U.S. Pat. No. 4,906,466 to Edwards). The disadvantages of the chemicals described above, such as hazard to humans, development of resistance and instability toward chemical influences, are not exhibited by certain heavy metal ions, such as silver, copper, zinc, or nickel and their organic compounds.

Thus there is a desire for a material that includes the antimicrobial properties of metals that is long lasting and safe to use. In addition to the antimicrobial material being safe and long lasting, the material must also be easy to coat or install on the surface of an object. Ideally, one would desire to replace the surface of an object entirely with a new surface that includes antimicrobial additives. However, replacement can be very costly and is not possible in all cases. For example, it is relatively easy to replace a door or a countertop; it is much harder or impossible to replace a wall of a building. Thus, a way of protecting surfaces from microbes that does not require replacing the entire original surface is desirable.

The instant invention is designed to address the above mentioned problems by providing an antimicrobial surface or antimicrobial coating for a surface that is safe, effective, long lasting, and can easily be added to the surface of an existing object.

### SUMMARY OF THE INVENTION

The present invention is an anti-microbial surface and surface coating. The antimicrobial surface and surface coating includes an antimicrobial material on the surface of an object. The antimicrobial material includes: a metallic flake; an epoxy resin; an epoxy hardener; and a surfactant. The metallic flake is between 45-80% by weight of the antimicrobial material. The epoxy resin is between 10-25% by weight of the antimicrobial material. The epoxy hardener is between 1-10% by weight of the antimicrobial material. The surfactant is between 5-15% by weight of the antimicrobial material.

### DETAILED DESCRIPTION OF THE INVENTION

The present invention is an antimicrobial material made from a unique blend of chemicals from which surfaces and coatings for surfaces can be made. The antimicrobial material may provide a kill rate for any microbes, including, but not limited to, microorganisms such as bacteria, fungi, spores, viruses, etc. The antimicrobial material of the instant invention may be included or applied to the surface of any object for providing antimicrobial prevention to the object. This includes, but is not limited to: private and public transportation vehicles and any associated buildings such as airports, bus and train stations; theaters; hospitals; all care giving facilities including nursing homes, clinics, doctors offices and day care centers; all children's program facilities including schools, universities, dormitories, and camps; hotels; restaurants; residential buildings including homes and apartments; exercise facilities; grocery, convenience and retail facilities; business service buildings; public buildings; entrance and exit handles, knobs, bars or plates to buildings both internal and external; country clubs; clubs; cruise ships; cafeterias; laboratories; and any structure capable of attracting or retaining microbes.

Some items located in the above listed buildings, facilities or vehicles would include but not limited to: wheelchairs; exercise equipment; handles, latches or knobs of all nature, located on any door, or equipment; accessories; all forms of keys; touch pads; elevator buttons; escalator rails; hand rails; counter tops; plumbing fixtures and accessories; carts of all kinds to include hospital, food handling or shopping; furniture, furnishings and fixtures including desks, armrests; dispensers including paper towel, soap, toilet paper tissue, beverage fountains or coolers, vending machines and grocery display doors; all forms of hospital equipment to include IV poles, door openers, hospital patient trays, bed tables, triage and blood draw areas and equipment, remote controls, bed railings, walls, and floors, handicap equipment including hand rails and wheel chair handles, and ambulances; all forms of trays; baby equipment including furniture, fixtures, accessories and bottles; electronic controls or buttons; luggage handles; food utensils and any other object or structure capable of attracting or retaining microbes.

The antimicrobial material of the instant invention may also be included or applied to the surface of any object for providing antimicrobial prevention to the object in outside areas. These outside areas may include: ATM machines; playgrounds; obstacle courses; boat bottoms to reduce crustacean build up; and any other outside object or structure capable of attracting or retaining microbes.

Specific examples of objects to have surfaces with the antimicrobial material of the instant invention may include, but are not limited to: airplane trays, latches and arm rests; all areas for passengers to hold on to in airport trams; airport, bus and train common areas, like bathrooms, ticket agent counter tops, waiting areas and seating chair armrests; ambulance handles and ambulance bed frames; ATM machines; baby bottles, furniture and accessories; rooms in hospitals, nursing homes, hotels, day care centers, etc.; wards in hospitals, nursing Homes, etc., boat bottoms to reduce crustacean build up; all forms of carts (store, hospital, food, shopping, etc.); chairs (common area armrests, waiting areas, doctors, airplane, bus and train seats, theater etc.); coffee pots and cream handles, display handles and dispensing buttons in stores and businesses; vending machines; counter tops; cruise ships, including all common areas and state room bathrooms and cabin doors; day care centers; display door handles such as grocery freezer display doors; doctors offices; entrances and exits to buildings both internal and external; exercise equipment; home use, including flushers, toilet paper rolls, refrigerator and microwave handles, door entrances, plumbing fixtures, cabinet door handles, etc.; hospital rooms including bed railings, IV poles, bathroom door handles, flushers, faucets, bathroom railings, soap and paper towel dispenser, faucets, toilet paper holder, toilet seat, bed table, visitor chairs in room, and walkers; other areas in hospitals including reception desk, triage area, drawn blood areas, railings in hallways, railings on stairs, general restrooms, the electric buttons to enter wards, waiting room armrests, operating rooms, doctor scrub rooms, doctor's locker latch, refrigerator and microwave handles, nurse stations, walls and floors, cafeteria common areas, etc.; government buildings; laboratories; locker handles; elevator buttons, escalator handrails, handicap equipment; lunch rooms including microwave, cabinet and refrigerator handles, etc.; luggage handles; mass transit structures including user holding areas such as poles and backs of chairs; nursing homes; paper towel and soap dispensers; playgrounds; plumbing fixtures; private clubs; public bathrooms; public exercise equipment; schools; sorority and fraternity houses; food utensils; buffet restaurants or salad bars; universities/colleges; YMCA's boys and girls clubs; amusement park rides and queuing areas; water cooler handles and water fountains plus spigot, and any other object or structure that is capable of attracting or retaining microbes.

The antimicrobial material of the instant invention may generally be made of: a metallic flake; an epoxy resin; an epoxy hardener; and a surfactant. These materials and their appropriate weight percentages of the antimicrobial material are discussed in further detail below.

A metallic flake material may be included in the antimicrobial material of the instant invention. A metallic flake, as used herein, refers to a flake of heavy metallic material, i.e., a small thin piece of heavy metallic material. A metallic flake may not be a common metallic powder, a metallic resin, nor a cylindrical metallic material. In one embodiment, a metallic flake may be a small thin piece from 1 to 20 microns. In another embodiment, a metallic flake may be a small thin piece from 1 to 5 microns. The metallic flake used in the instant invention may be any type of heavy metal provided in a flake form that provides antimicrobial properties. This includes, but is not limited to, copper flakes, silver flakes, nickel flakes, zinc flakes, alloy flakes, and combinations thereof. In one embodiment of the instant invention, the metallic flake may be a copper flake (CU flake) having a size of 1 to 5 microns and being 99.9% copper. An example of a copper flak that may be used in the instant invention may be provided by Atlantic Equipment Engineers of Bergenfield, N.J. under the product name CU-101 Copper Metal Flake, 99.9% 1-5 MICRON. Because the instant invention uses metallic flakes instead of powder or resin, the metallic antimicrobial properties of the metallic flakes are provided at a greater surface area per weight of metallic material used. This means less metallic flake may be required, by weight, as compared to metallic powders or resins, to provide adequate surface area of the metallic material. By providing more surface area by weight, the antimicrobial material may kill more microbes with a lower percentage of metallic material. In one embodiment, the metallic flake may be between 45%-80% by weight of the antimicrobial material. In another embodiment, the metallic flake may be between 50%-75% by weight of the antimicrobial material. In yet another embodiment, the metallic flake may be between approximately 60%-68% by weight of the antimicrobial material.

An epoxy resin material may be included in the antimicrobial material of the instant invention. Epoxy resin, as used herein, refers to monomers or short chain polymers with an epoxide group at either end. Most common epoxy resins are produced from a reaction between epichlorohydrin and bisphenol-A, though the latter may be replaced by similar chemicals. In one embodiment, the epoxy resin of the instant invention may be a mean cured 2 part epoxy catalyst resin, or an epoxy base material. In another embodiment, the epoxy resin may be a Bisphenol A based epoxy resin. This type of epoxy resin may contain greater than 20% Bisphenol-A based type epoxy resin mixed with less than 20% Benzyl alcohol, less than 20% Bisphenol-F type epoxy resin, and less than 0.3% Ethylene glycol monobutyl ether. For example, a suitable epoxy resin for use in the instant invention is a WEST SYSTEM® 105™ Epoxy Resin provided by West System Inc. of Bay City, Mich. In one embodiment, the epoxy resin may be between 50-30% by weight of the antimicrobial material. In another embodiment, the epoxy resin may be between 10%-20% by weight of the antimicrobial material. In yet another embodiment, the epoxy resin may be between approximately 14%-17% by weight of the antimicrobial material.

An epoxy hardener material may be included in the antimicrobial material of the instant invention. Epoxy hardener, as used herein, refers to polyamine monomers, for example, Triethylenetetramine (TETA). The epoxy hardener of the instant invention may be any hardener material, including, but not limited to, a mean cured 2 part epoxy hardener, catalyst, or curing agent. The epoxy hardener may be any Amine material, including, but not limited to a modified polyamine. In one embodiment, the epoxy hardener may be a mixture of 25-50% polyoxypropylenediamine, less than 25% reaction products of isophorone diamine with phenol/formaldehyde, less than 25% isophoronediamine, less than 25% reaction products of benzene-1, 3-dimethaneamine with hydroxybenzene and formaldehyde, less than 12% hydroxybenzene, and less than 12% m-Xylene diamine. For example, a suitable epoxy hardener for use in the instant invention is a WEST SYSTEM® 207 Special Coating Hardener provided by West Systems, Inc. of Bay City Mich. In one embodiment, the epoxy hardener may be between 1%-10% by weight of the antimicrobial material. In another embodiment, the epoxy hardener may be between 3%-6% by weight of the antimicrobial material. In yet another embodiment, the epoxy hardener may be between approximately 3.8%-4.5% by weight of the antimicrobial material.

A surfactant material may be included in the antimicrobial material of the instant invention. Surfactant, as used herein, refers to a wetting agent or compounds that lower the surface tension of a liquid, allowing easier spreading, and lowering of the interfacial tension between two liquids, or between a liquid and a solid. The instant antimicrobial material may include any form of surfactant, including, but not limited to, a mixture of greater than 65% of Ethoxylated 2,4,7,9-tetramethyl 5 decyn-4,7-diol 9014-85-1, greater than 25% of Tetramethyl-5-decyne-4,7-diol, 2,4,7,9-, 126-86-3, and Ethoxylated Acetylenic Diols. An example of such a surfactant may be provided by Air Products and Chemicals, Inc. of Allentown, Pa. under the product name SURFYNOL® 420 Surfactant. The surfactant of the instant invention may be mixed together all at once with the antimicrobial material, or it may be divided into different portions that are mixed together at different stages of the process. These different portions may be the same surfactant, or they may be different. In one embodiment, the total surfactant may be between 3%-25% by weight of the antimicrobial material. In another embodiment, the total surfactant may be between 5%-20% by weight of the antimicrobial material. In yet another embodiment, the total surfactant may be between approximately 7.8%-14.2% by weight of the antimicrobial material.

The antimicrobial material of the instant invention may also include other ingredients. These ingredients, include, but are not limited to: iodine solution, a thickener, a hand soap, a defoamer, and/or an antimicrobial ingredient. These additional materials and there appropriate weight percentages of the antimicrobial material are discussed in further detail below.

Iodine solution may be included in the antimicrobial material of the instant invention. Iodine solution, as used herein, refers to any common iodine solution. The iodine solution may be a commercial product with varying concentration of iodine, including, but not limited to, products having a concentration of iodine ranging between 1-20%. The iodine solution of the instant invention may be decolorized iodine or iodine tincture. The iodine solution of the instant invention may provide the antimicrobial material with a virus killing property. In one embodiment, the iodine solution of the instant invention may be a standard providone-iodine solution. Providone-iodine may be a stable chemical complex of polyvinylpyrrolidone (povidone, PVP) and elemental iodine. It may contain from 9.0% to 12.0% available iodine, calculated on a dry basis. An example of an iodine solution that may be used in the instant invention may be provided by Farnam Companies, Inc. of Phoenix, Ariz., under the product name POVIDONE-IODINE SOLUTION 10%. In one embodiment, the iodine solution may be between 0.5%-1% by weight of the antimicrobial material. In another embodiment, the iodine solution may be between 0.7%-0.9% by weight of the antimicrobial material. In yet another embodiment, the iodine solution may be between approximately 0.78%-0.87% by weight of the antimicrobial material.

A thickener may be included in the antimicrobial material of the instant invention. Thickener, as used herein, refers to thickening agents, flow modifiers, fillers, etc. or substances which, when added to an aqueous mixture, increase its viscosity without substantially modifying its other properties. Thickeners are materials known to provide body, increase stability, and improve suspension of added ingredients. Some thickening agents are gelling agents, forming a gel, which dissolve in the liquid phase as a colloid mixture that forms a weakly cohesive internal structure. The thickener of the instant invention may be any thickener, including, but not limited to, a fumed silica thickener or a silicon dioxide (amorphous. An example of a thickener may be provided by Epoxies, Etc. of Cranston, R.I. under the trade name 20-3068RCL (article number: Epoxy Resin Formulation). Another example of a thickener may be provided by Tokuyama Corp. of Tokyo, Japan under the product name REOLOSIL (Hydrophilic Type: CP&QS-Grade). In one embodiment, the thickener may be between 0.1%-5% by weight of the antimicrobial material. In another embodiment, the thickener may be between 0.5%-1.5% by weight of the antimicrobial material. In yet another embodiment, the thickener may be between approximately 0.78%-1.3% by weight of the antimicrobial material.

A hand soap and defoamer may be included in the antimicrobial material of the instant invention. The amount of defoamer in the antimicrobial material may be related to the amount of hand soap in the antimicrobial material, i.e., if hand soap is included an appropriate amount of defoamer must be included to defoam the hand soap. Hand soap, as used herein, refers to any common liquid hand soap. The hand soap may include, but is not limited to, the ingredients of: biodegradable anionic and nonionic surfactants and no phosphate. In one embodiment, the hand soap may include: water; ammonium C12-15 pareth sulfate; SD alcohol 3-A; lauramidopropylamine oxide; sodium chloride; magnesium sulfate; poloxamer 124; pentasodium pentatate; preservative; sodium bisulfite; and/or any fragrances or dyes. For example, the hand soap included in the instant invention may be Palmolive® Dish Liquid (all variants) provided by Colgate-Palmolive Canada, Inc. of Toronto Canada. In another embodiment, the hand soap may include: biodegradable anionic and nonionic surfactants and no phosphate with Ethyl alcohol. As another example, the hand soap may be DAWN® (all variants) Liquid Hand Dishwashing Detergents Finished, Packaged Product, provided by Proctor & Gamble of Cincinnati, Ohio. Defoamer, as used herein, refers to a desuder, anti-foaming agent or a chemical additive that reduces and hinders the formation of foam in industrial process liquids. In one embodiment, the defoamer may be a mixture containing between 1-10% Propylene Glycol. For example, the defoamer may be, but is not limited to, a defoamer product provided by Munzing—Ultra Additives LLC., of Bloomfield, N.J. under the product name FOAM BAN® HP720 (Product ID-U2HP720). In one embodiment, the hand soap may be between 0.5%-7% by weight of the antimicrobial material and the defoamer may be between 0.1%-3% by weight of the antimicrobial material. In another embodiment, the hand soap may be between approximately 1.6%-5.5% by weight of the antimicrobial material and the defoamer may be between approximately 0.4%-1.7% by weight of the antimicrobial material.

An antimicrobial ingredient may be included in the antimicrobial material of the instant invention. Antimicrobial ingredient, as used herein, refers to any substance like a powder or liquid that is known to provide antimicrobial properties. This may include, but is not limited to, triclosan, baking power, neem oil, tea tree oil, grapefruit seed extract, pine oil aloe vera, witch hazel, neem oil, and/or borax. Any reference to the antimicrobial ingredient may include any of the aforementioned or any combination thereto. The antimicrobial ingredient may also include any products having the same, approximate or similar beneficial properties.

In one embodiment, the antimicrobial ingredient may be between 0.01%-1% by weight of the antimicrobial material. In another embodiment, the antimicrobial ingredient may be between approximately 0.11%-0.13% by weight of the antimicrobial material.

Triclosan, as used herein, refers to an antibacterial and antifungal agent. Triclosan may be used as the antimicrobial ingredient included in the antimicrobial material of the instant invention. Triclosan is an organic compound that is a white powdered solid with a slight aromatic/phenolic odor. It is a chlorinated aromatic compound which has functional groups representative of both ethers and phenols (phenols often show antibacterial properties). The triclosan of the instant invention may include, but is not limited to, phehol5-chloro-2-(2,4-clichlorophenoxy). An example of a triclosan material may be provided by “WIRUD” Co. Ltd. of Hong Kong under the product name Triclosan. Another example of an acceptable triclosan for use in the antimicrobial material of the instant invention is Ciba® Irgasan® DP 300 provided by BASF Chemical Company of Florham Park, N.J.

Baking powder, as used herein, refers to a dry chemical raising agent used to increase the volume and lighten the texture of baked goods such as muffins, cakes, scones and biscuits. Baking powder may be used as the antimicrobial ingredient included in the antimicrobial material of the instant invention. Baking powder typically includes an alkaline component (typically baking soda, also known as sodium bicarbonate), one or more acid salts, and an inert starch (cornstarch in most cases, though potato starch may also be used). Baking soda is the source of the carbon dioxide,[3] and the acid-base reaction is more accurately described as an acid-activated decomposition of baking soda, which can be generically represented as: NaHCO3+H+→Na++CO2+H2O. The inert starch serves several functions in baking powder. Primarily it is used to absorb moisture, and thus prolong shelf life by keeping the powder's alkaline and acidic components from reacting prematurely. A dry powder also flows and mixes more easily and the added bulk allows for more accurate measurements. The baking powder of the instant invention may include any form of baking powder, including, but not limited to, a mixture of sodium bicarbonate, sodium pyrophosphate, corn starch, monocalcium phosphate, and/or calcium sulfate. An example of a baking powder material suitable for the instant invention may be provided by Aldon Corporation of Avon, N.Y. under the product name BAKING POWDER.

Neem oil, as used herein, refers to a vegetable oil that comes from the seed, bark and leaves of the azadirachta indica, i.e., the neem tree. Neem oil may be used as the antimicrobial ingredient included in the antimicrobial material of the instant invention. Neem oil comes from the seed and it's a pressed oil, more like an olive oil than a tea tree oil. Neem oil is generally light to dark brown, bitter and has a rather strong odour that is said to combine the odours of peanut and garlic. It comprises mainly triglycerides and large amounts of triterpenoid compounds, which are responsible for the bitter taste. It is hydrophobic in nature and in order to emulsify it in water for application purposes, it must be formulated with appropriate surfactants. Neem oil also contains steroids (campesterol, beta-sitosterol, stigmasterol) and a plethora of triterpenoids of which azadirachtin is the most well known and studied. The azadirachtin content of neem oil varies from 300 ppm to over 2500 ppm depending on the extraction technology and quality of the neem seeds crushed. The method of processing is likely to affect the composition of the oil, since the methods used, such as pressing (expelling) or solvent extraction are unlikely to remove exactly the same mix of components in the same proportions. The neem oil yield that can be obtained from neem seed kernels also varies widely in literature from 25% to 45%. The oil can be obtained through pressing (crushing) of the seed kernel both through cold pressing or through a process incorporating temperature controls. Neem seed oil can also be obtained by solvent extraction of the neem seed, fruit, oil, cake or kernel. A large industry in India extracts the oil remaining in the seed cake using hexane. This solvent-extracted oil is of a lower quality as compared to the cold pressed oil and is mostly used for soap manufacturing. An example of a neem oil suitable for the antimicrobial ingredient for the instant invention is provided by Natural Sourcing™ of Oxford Conn., under the product name NEEM OIL.

Other ingredients may also be included in the instant invention of an antimicrobial material. These ingredients, include, but are not limited to: a lacquer thinner, additional thickeners, silicone dioxide, ethyl lactate blend, an acetone replacement, and/or MEK. The lacquer thinner, or reducing agent may be a high solvency medium drying thinner for lacquer and epoxy. An example of a lacquer thinner may be provided by W. M. Barr of Memphis, Tenn. under the product name Lacquer Thinner. Additional thickeners may be, but are not limited to, fumed silica thickeners, and/or colloidal sillica thickeners. An example of a fumed silica thickener may be provided by West Systems, Inc. of Bay City, Mich. under the product name West System Colodial Silica Flow Modifier (add to resin only) Fumed Silica. An example of a colloidal silica thickener may be provided by West Systems, Inc. of Bay City, Mich. under the product name WEST SYSTEM® 406™ Colloidal Sillica. The silicone dioxide ingredient may be a 100% SiO₂ material. An example of a silicone dioxide may be provided by Tokuyama Corp. of Tokyo, Japan under the product name REOLOSIL. The ethyl lactate ingredient may be a proprietary co-solvent or inhibitor (acetone replacement). The ethyl lactate ingredient may be 10-90 percent ethyl hydroxyl propionate/proprietary co-solvent. An example ethyl lactate material may be provided by Phoenix Resins, Inc. of Cinnaminson, N.J. under the product name BIO-SOLV. An acetone replacement material may be provided by W. M. Barr of Memphis, Tenn. under the product name Klean-Strip Acetone. The MEK ingredient may be, but is not limited to, a thinner, or reducing agent that may be a Butanone or Methol Ethyl Ketone. Butanone, also known as methyl ethyl ketone or MEK, is an organic compound with the formula CH₃COCH₃ (2-propanone, propanone). MEK is produced industrially on a large scale, and also occurs in trace amounts in nature. An example of a MEK ingredient may be provided by W. M. Barr of Memphis, Tenn. under the product name Klean Strip Methyl Ethyl Ketone. Other additional or substituted ingredients could include linseed oil (for added flexibility to material) and/or hydrated lime (affective against mold and mildew).

Once added to the surface of an object, the resulting antimicrobial surface could be cleaned by any means. For example, the resulting service could be cleaned once a month with an iodine solution. As another example, the resulting antimicrobial surface may be cleaned with soap, water, or a combination of soap and water, daily, weekly, and/or as needed.

The antimicrobial material of the instant invention may be provided in any form on a surface of an object. For example, the antimicrobial material may be, but is not limited to, a dip formula, a brush paint furmula, a spray paint formula, a solid material formula, and an injection mold formula. Examples of each of theses forms of the antimicrobial material are discussed below.

### EXAMPLES

### Example 1

### Brush Paint Formula

The instant invention may be provided in a brush paint formula. The brush paint formula may be utilized to paint an object with a brush or roller for coating the surface of the object. A brush paint formula was made with the following ingredients: copper flake, epoxy resin, epoxy hardener, surfactant, iodine solution, thickener, hand soap, defoamer, and triclosan. The brush paint formula was made according to the following steps. First, the epoxy resin was measured out to 3.7 grams. The thickener was then measured out to 0.2 grams and mixed by suitable technique to the epoxy resin. The surfactant was then measured out to 2.2 grams and mixed by suitable technique to the epoxy resin and thickener mixture. The triclosan was then measured out to 0.03 grams and mixed by suitable technique with the epoxy resin, thickener and surfactant mixture. The hand soap was then measured out to 1.37 grams and mixed by suitable technique to the epoxy resin, thickener, surfactant and triclosan mixture. The defoamer was then measured out to 0.4 grams and mixed by suitable technique to the epoxy resin, thickener, surfactant, triclosan and hand soap mixture. Next, the copper flake was measured out to be 15.5 grams. The copper flake was then mixed together by suitable technique with the solution of epoxy resin, thickener, surfactant, triclosan, hand soap, and defoamer. Next, the epoxy hardener was measured out to 1.0 grams and the iodine solution was measured out to 0.2 grams. The iodine solution and epoxy hardener were then mixed together by suitable technique with 1.0 grams of a second surfactant. The second surfactant may be similar to the first surfactant. Finally, the solution of iodine solution, epoxy hardener, and the second surfactant was then mixed together by suitable technique with the solution of all the other materials.

This resulted in 25.6 grams of brush paint formula with the copper flake being approximately 60.54% by weight of the brush paint formula; the epoxy resin being approximately 14.45% by weight of the brush paint formula; the epoxy hardener being approximately 3.9% by weight of the brush paint formula; the total surfactant being approximately 12.49% by weight of the brush paint formula; the iodine solution being approximately 0.78% by weight of the brush paint formula; the thickener being approximately 0.78% by weight of the brush paint formula; the hand soap being approximately 3.9% by weight of the brush paint formula; the defoamer being approximately 1.56% by weight of the brush paint formula; and the triclosan being approximately 0.11% by weight of the brush paint formula.

Once the brush paint formula was created, the final mixture was then painted on an object using a very soft brush with about 150 micron thick bristles using even strokes to accomplish total coverage. The painted object was then allowed to air dry between 8 and 10 hours for dry to touch cure. Other objects were heat dried using hear lamps for between 2 and 4 hours at 70° C. Using this brush paint formula an antimicrobial coating was added to the surface of the objects.

Life expectancy or durability tests were performed on the brush paint formula using the fabric side of a Velcro sheet mounted on a wheel and allowed to rub a tube sample of the material. The fabric side of a Velcro strip was mounted to the shaft of an electric motor. An antimicrobial surfaced tube, thickness 230 Micron, was adjusted so that the Velcro fabric side would come in contact with the tube 2.3 times per second; equating to 202,176 times per 24 hour day. After 24 hour testing the wear was approximately 0.5 Microns (so minor that it could not be measured). This wear equates to a touch life expectancy of about 90,000,000 hard rubs. This life expectancy testing was run three (3) separate times yielding the same basic conclusions, the surface wear was so minor that it could not be accurately measured.

Antimicrobial kill rate tests were also performed on the brush paint formula with E. coli cells (amp resistant) with a LB agar supplemented with 100 μg/ml lampicillin medium. Copper impregnated surface was scraped to a shine, rinsed in etOH, dried under an infrared lamp. 2 μl cells from overnight culture were spread on surface and incubations were carried out for 30 minutes and 1 hour under 100% humid conditions. The copper pieces were transferred to 5 ml PBS and vortexed to release the cells. Appropriate dilutions were plated on LB Ampplates. The results were that the control plate had 954 colonies. All other plates had none except #95, which at the 1 hour time-point had 3 colonies.

Another antimicrobial kill rate test was performed on the antimicrobial material of the instant invention. 400 cells, or about 2 microliters of cells, were introduced to each sample. The control, which had no exposure to the copper samples, grew 127 colonies. So this growth rate is 100%. So based on this, the kill rate for sample 1 at 5 minutes would be 60% (51/127 grew). In Table 1 below are results for the experiment for 4 different samples: 1 sq cm pieces of the 4 samples were washed in 100% ethanol and air dried under infrared lamp. Copper surfaces were smeared with 2 μl of ON culture of S aureus. The control consisted of 2 μl of cells from ON culture. The pieces were transferred to sterile saline solution at 5 minute and 15 minute intervals, and appropriate dilutions were plated on LB Agar plates. Yellow colonies were counted after 36 hr incubation at RT.

TABLE 1

| | 5 minutes | | 15 minutes | |
|---|---|---|---|---|
| | Number of | Kill | Number of | Kill |
| | Colonies | Rate | Colonies | Rate |
| Control | 127 | 0% | | |
| Sample 1 | 51 | 60% | 22 | 83% |
| Sample 2 | 36 | 72% | 3 | 98% |
| Sample 3 | 38 | 70% | 10 | 92% |
| Sample 4 | 22 | 83% | 0 | 100% |

Another kill rate test was performed on the brush paint formula. Analysis was performed on of 2 preps: #14 (thick sample 740 μm); and #140 (thin sample 400 μm). In both samples, one side was polished and was shiny (S), while the other side was dull (D). Bacterial cells were spread evenly on the surfaces. 1 hour and 2 hour time points (incubation time) were included in the analysis. The control plates had 195 and 427 colonies respectively (5 μl of 10 e-4 dilution). The number of colonies on 14S after 1 hour was 3 colonies. Al other plates had no colonies, i.e., they had a 100% kill rate.

### Example 2

### Dip Formula

The instant invention may be provided in a dip formula. The dip formula may be utilized to dip an object into the formula for coating the surface of the object. A dip formula was made with the following ingredients: copper flake, epoxy resin, epoxy hardener, surfactant, iodine solution, thickener, hand soap, defoamer, and triclosan.

The dip formula was made according to the following steps. First, the epoxy resin was measured out to 3.7 grams. The thickener was then measured out to 0.2 grams and mixed by suitable technique to the epoxy resin. The defoamer was then measured out to 0.4 grams and mixed by suitable technique to the epoxy resin and thickener mixture. The hand soap was then measured out to 1.0 grams and mixed by suitable technique to the epoxy resin, thickener and defoamer mixture. The first portion of surfactant was then measured out to 1.5 grams and mixed by suitable technique to the epoxy resin, thickener, defoamer and hand soap mixture. Next, the copper flake was measured out to be 15.5 grams. The copper flake was then mixed together by suitable technique with the solution of epoxy resin, thickener, surfactant, triclosan, hand soap, and defoamer. Next, the iodine solution was measured out to 0.2 grams and the epoxy hardener was measured out to 1.0 grams. The iodine solution and epoxy hardener were then mixed together by suitable technique with 1.0 grams of the second portion of the surfactant. Finally, the solution of iodine solution, epoxy hardener, and surfactant was then mixed together by suitable technique with the solution of all the other materials.

This resulted in 24.53 grams of dip formula with the copper flake being approximately 62.24% by weight of the dip formula; epoxy resin being approximately 15.08% by weight of the dip formula; epoxy hardener being approximately 4.07% by weight of the dip formula; the total surfactant being approximately 10.18% by weight of the dip formula; iodine solution being approximately 0.81% by weight of the dip formula; thickener being approximately 0.81% by weight of the dip formula; the hand soap being approximately 4.07% by weight of the dip formula; the defoamer being approximately 1.63 weight of the dip formula; and the triclosan being approximately 0.12% by weight of the dip formula.

Once the dip formula was created, the final mixture was placed in a vat where objects were dipped into the mixture for 30 seconds then raised and allowed to gravity drip for 5 minutes. The gravity dripped parts were then moved to a 90° C. oven for 2 hours. The material was then finally cured by letting it air dry for 8 to 10 hours. The finally cured material was then surfaced using 000 steel wool to achieve an antique finish. Using this dip formula an antimicrobial coating was added to the surface of the objects. Similar results are expected for the dip formula as shown above for the brush paint formula.

### Example 3

### Spray Paint Formula

The instant invention may be provided in a spray paint formula. The spray paint formula may be utilized to paint an object with a paint sprayer for coating the surface of the object. A spray paint formula was made with the following ingredients: copper flake, epoxy resin, epoxy hardener, surfactant, iodine solution, thickener, hand soap, defoamer, and triclosan, and lacquer thinner. The spray paint formula was made according to the following steps. First, the epoxy resin was measured out to 3.7 grams. The thickener was then measured out to 0.2 grams and mixed by suitable technique to the epoxy resin. A first portion of the surfactant was then measured out to 1.0 grams and mixed by suitable technique to the epoxy resin and thickener mixture. The hand soap was then measured out to 1.37 grams and mixed by suitable technique to the epoxy resin, thickener, and surfactant mixture. The defoamer was then measured out to 0.3 grams and mixed by suitable technique to the epoxy resin, thickener, surfactant and hand soap mixture. The triclosan was then measured out to 0.03 grams and mixed by suitable technique with the epoxy resin, thickener, surfactant, hand soap and defoamer mixture. Next, the copper flake was measured out to be 15.5 grams. The copper flake was then mixed together by suitable technique with the solution of epoxy resin, thickener, surfactant, triclosan, hand soap, and defoamer. Next, the epoxy hardener was measured out to 1.0 grams and the iodine solution was measured out to 0.2 grams. A lacquer thinner was measured out to 1.4 grams and mixed together with the iodine solution and epoxy hardener by suitable technique. The lacquer thinner will rapidly evaporate and was thus not apart of the final antimicrobial material. The lacquer thinner may be a reducing agent or a high solvency medium drying thinner for lacquer and epoxy. This solution of iodine solution and epoxy hardener was then mixed together by suitable technique with 1.7 grams of the second portion of the surfactant. Finally, the solution of iodine solution, epoxy hardener and surfactant was mixed together by suitable technique with the solution of all the other materials.

This resulted in 25.0 grams of spray paint formula with the copper flake being approximately 62% by weight of the spray paint formula; the epoxy resin being approximately 14.8% by weight of the spray paint formula; the epoxy hardener being approximately 4% by weight of the spray paint formula; the surfactant being approximately 8% by weight of the spray paint formula; the iodine solution being approximately 0.8% by weight of the spray paint formula; the thickener being approximately 0.8% by weight of the spray paint formula; the hand soap being approximately 5.48% by weight of the spray paint formula; the defoamer being approximately 1.2% by weight of the spray paint formula; and the triclosan being approximately 0.12% by weight of the spray paint formula.

Once the spray paint formula was created, the final mixture was then painted on an object using a high volume low pressure spray gun or an air brush between 90 and 150 micron thick using even spray strokes to accomplish total coverage. The painted object was then allowed to air dry between 8 and 10 hours for dry to touch cure. Other objects were heat dried using hear lamps for between 2 and 4 hours at 90° C. Using this spray paint formula an antimicrobial coating was added to the surface of the objects. Similar results are expected for the spray paint formula as shown above for the brush paint formula.

### Example 4

### Solid Material Formula

The instant invention may be provided in a solid material formula. The solid material formula may be utilized for creating the actual surface for an object. A solid material formula was made with the following ingredients: copper flake, epoxy resin, epoxy hardener, surfactant, iodine solution, thickener, hand soap, defoamer, and triclosan. The solid material formula was made according to the following steps. First, the epoxy resin was measured out to 3.7 grams. The thickener was then measured out to 0.3 grams and mixed by suitable technique to the epoxy resin. The defoamer was then measured out to 0.1 grams and mixed by suitable technique to the epoxy resin and thickener mixture. The hand soap was then measured out to 0.4 grams and mixed by suitable technique to the epoxy resin, thickener, and defoamer mixture. The triclosan was then measured out to 0.03 grams and mixed by suitable technique with the epoxy resin, thickener, defoamer and hand soap mixture. The surfactant was then measured out to 1.8 grams and mixed by suitable technique to the epoxy resin, thickener, defoamer, hand soap and triclosan mixture. Next, the epoxy hardener was measured out to 1.0 grams and the iodine solution was measured out to 0.2 grams. The iodine solution and epoxy hardener were then mixed together by suitable technique. Next, the copper flake was measured out to be 15.5 grams. Finally, the copper flake was mixed together by suitable technique with the solution of iodine solution and epoxy hardener and the solution of epoxy resin, thickener, defoamer, hand soap, triclosan and surfactant.

This resulted in 23.03 grams of solid material formula with the copper flake being approximately 67.3% by weight of the solid material formula; the epoxy resin being approximately 16.06% by weight of the solid material formula; the epoxy hardener being approximately 4.43% by weight of the solid material formula; the surfactant being approximately 7.81% by weight of the solid material formula; the iodine solution being approximately 0.87% by weight of the solid material formula; the thickener being approximately 0.87% by weight of the solid material formula; the hand soap being approximately 1.73% by weight of the solid material formula; the defoamer being approximately 0.43% by weight of the solid material formula; and the triclosan being approximately 0.13% by weight of the solid material formula.

Once the solid formula was created, the final mixture resulted in a paste type substance. The paste substance was then put into a heat and pressure mold (Micron thickness determined by application) using mold release. The mold was then partially cured at 90° C. for 2 hours. The partially cured mold may then be removed from the mold and rinsed with water. The molded material was then let to air dry for 8 to 10 hours to finally cure the material. The material was then surfaced using 000 steel wool to achieve an antique finish. The solid material can then be formed using a roller system. Using this solid material formula an antimicrobial surface for objects was created. Similar results are expected for the solid material formula as shown above for the brush paint formula.

### Example 5

### Injection Mold Formula

The instant invention may be provided in an injection mold formula. The injection mold formula may be utilized for creating an injection molded object or an injection molded surface for an object. An injection mold formula was made with the following ingredients: copper flake, epoxy resin, epoxy hardener, surfactant, iodine solution, thickener, hand soap, defoamer, and triclosan. The injection mold formula was made according to the following steps. First, the epoxy resin was measured out to 3.7 grams. The defoamer was then measured out to 0.1 grams and mixed by suitable technique to the epoxy resin. The hand soap was then measured out to 0.4 grams and mixed by suitable technique to the epoxy resin, and defoamer mixture. The triclosan was then measured out to 0.03 grams and mixed by suitable technique with the epoxy resin, defoamer and hand soap mixture. A first portion of the surfactant was then measured out to 1.8 grams and mixed by suitable technique to the epoxy resin, defoamer, hand soap and triclosan mixture. The thickener was then measured out to 0.3 grams and mixed by suitable technique to the epoxy resin, defoamer, hand soap, triclosan and surfactant mixture. Next, the epoxy hardener was measured out to 1.0 grams and the iodine solution was measured out to 0.2 grams. The iodine solution and epoxy hardener were then mixed together by suitable technique with 1.7 grams of a second portion of the surfactant. This mixture of iodine solution, epoxy hardener, and surfactant was then mixed with the epoxy resin, defoamer, hand soap, triclosan, surfactant, and thickener mixture by suitable technique. Next, the copper flake was measured out to be 15.5 grams. Finally, the copper flake was mixed together by suitable technique with the mixture of all other materials.

This resulted in 24.73 grams of injection mold formula with the copper flake being approximately 62.97% by weight of the injection mold formula; the epoxy resin being approximately 14.96% by weight of the injection mold formula; the epoxy hardener being approximately 4.04% by weight of the injection mold formula; the total surfactant being approximately 14.14% by weight of the injection mold formula; the iodine solution being approximately 0.8% by weight of the injection mold formula; the thickener being approximately 1.21% by weight of the injection mold formula; the hand soap being approximately 1.61% by weight of the injection mold formula; the defoamer being approximately 0.4% by weight of the injection mold formula; and the triclosan being approximately 0.12% by weight of the injection mold formula.

Once the injection mold material was created, the final mixture resulted in a liquid substance. The liquid substance was then put into an injection molding unit (Micron thickness may be determined by application). The injection mold was then partially cured at 90° C. for 2 hours. The partially cured injection mold was then removed from the injection mold and rinsed with water. The injection molded material was then let to air dry for 8 to 10 hours to finally cure the material. The material was then surfaced using 000 steel wool to achieve an antique finish. Using this injection molded formula an object with an antimicrobial surface was created. Similar results are expected for the injection mold formula as shown above for the brush paint formula.

The present invention may be embodied in other forms without departing from the spirit and the essential attributes thereof, and, accordingly, reference should be made to the appended claims, rather than to the foregoing specification, as indicated the scope of the invention.

I claim:

1. An antimicrobial surface comprising:
an antimicrobial material adapted to be added to the surface of an object;
said antimicrobial material comprising:
a metallic flake being between 45%-80% by weight of said antimicrobial material;
an epoxy resin being between 5%-30% by weight of said antimicrobial material;
an epoxy hardener being between 1%-10% by weight of said antimicrobial material; and
a surfactant being between 3%-25% by weight of said antimicrobial material.

2. The antimicrobial surface of claim 1 wherein:
said metallic flake being between 50%-75% by weight of said antimicrobial material;
said epoxy resin being between 10%-20% by weight of said antimicrobial material;
said epoxy hardener being between 3%-6% by weight of said antimicrobial material; and
said surfactant being between 5%-20% by weight of said antimicrobial material.

3. The antimicrobial surface of claim 1 wherein:
said metallic flake being between approximately 60%-68% by weight of said antimicrobial material;
said epoxy resin being between approximately 14%-17% by weight of said antimicrobial material;
said epoxy hardener being between approximately 3.8%-4.5% by weight of said antimicrobial material; and
said surfactant being between approximately 7.8%-14.2% by weight of said antimicrobial material.

4. The antimicrobial surface of claim 1 wherein said antimicrobial material further comprising:
an iodine solution being between 0.5%-1.0% by weight of said antimicrobial material; and
a thickener being between 0.1%-5% by weight of said antimicrobial material.

5. The antimicrobial surface of claim 4 wherein:
said iodine solution being between approximately 0.78%-0.87% by weight of said antimicrobial material; and
said thickener being between approximately 0.78%-1.30% by weight of said antimicrobial material.

6. The antimicrobial surface of claim 1 wherein said antimicrobial material further comprising:
a hand soap being between 0.5%-7% by weight of said antimicrobial material; and
a defoamer being between 0.1%-3% by weight of said antimicrobial material.

7. The antimicrobial surface of claim 6 wherein the amount of defoamer in said antimicrobial material being proportional to the amount of hand soap in said antimicrobial material.

8. The antimicrobial surface of claim 6 wherein:
said hand soap being between approximately 1.6%-5.5% by weight of said antimicrobial material; and
said defoamer being between approximately 0.44-1.7% by weight of said antimicrobial material.

9. The antimicrobial surface of claim 1 wherein said antimicrobial material further comprising an antimicrobial ingredient being between 0.01%-2% by weight of said antimicrobial material.

10. The antimicrobial surface of claim 9 wherein said antimicrobial ingredient being between approximately 0.11%-13% by weight of said antimicrobial material.

11. The antimicrobial surface of claim 9 wherein said antimicrobial ingredient being selected from the group consisting of: triclosan, baking power, neem oil, tea tree oil, grapefruit seed extract, pine oil aloe vera, witch hazel, neem oil, borax, and combinations thereof.

12. The antimicrobial surface of claim 1 wherein said metallic flake being selected from the group consisting of: a copper flake, a silver flake, a zinc flake, a nickel flake, and mixtures thereof.

13. The antimicrobial surface of claim 1 wherein said antimicrobial material being selected from the group consisting of: a dip formula, a brush paint furmula, a spray paint formula, a solid material formula, and an injection mold formula.

14. The antimicrobial surface of claim 13 wherein said dip formula consisting of:
said copper flake being approximately 62.24% by weight of said dip formula;
said epoxy resin being approximately 15.08% by weight of said dip formula;
said epoxy hardener being approximately 4.07% by weight of said dip formula;
said surfactant being approximately 10.18% by weight of said dip formula;
said iodine solution being approximately 0.81% by weight of said dip formula;
said thickener being approximately 0.81% by weight of said dip formula;
said hand soap being approximately 4.07% by weight of said dip formula;
said defoamer being approximately 1.63% by weight of said dip formula; and
said antimicrobial ingredient being approximately 0.12% by weight of said dip formula.

15. The antimicrobial surface of claim 13 wherein said brush paint formula consisting of:
said copper flake being approximately 60.54% by weight of said brush paint formula;
said epoxy resin being approximately 14.45% by weight of said brush paint formula;
said epoxy hardener being approximately 3.9% by weight of said brush paint formula;
said surfactant being approximately 12.49% by weight of said brush paint formula;
said iodine solution being approximately 0.78% by weight of said brush paint formula;
said thickener being approximately 0.78% by weight of said brush paint formula;
said hand soap being approximately 3.9% by weight of said brush paint formula;
said defoamer being approximately 1.56% by weight of said brush paint formula; and
said antimicrobial ingredient being approximately 0.11% by weight of said brush paint formula.

16. The antimicrobial surface of claim 13 wherein said spray paint formula consisting of:
said copper flake being approximately 62% by weight of said spray paint formula;
said epoxy resin being approximately 14.8% by weight of said spray paint formula;
said epoxy hardener being approximately 4% by weight of said spray paint formula;
said surfactant being approximately 8% by weight of said spray paint formula;
said iodine solution being approximately 0.8% by weight of said spray paint formula;
said thickener being approximately 0.8% by weight of said spray paint formula;
said hand soap being approximately 5.48% by weight of said spray paint formula;
said defoamer being approximately 1.2 by weight of said spray paint formula; and
said antimicrobial ingredient being approximately 0.12% by weight of said spray paint formula.

17. The antimicrobial surface of claim 13 wherein said solid material formula consisting of:
said copper flake being approximately 67.3% by weight of said solid material formula;
said epoxy resin being approximately 16.06% by weight of said solid material formula;
said epoxy hardener being approximately 4.43% by weight of said solid material formula;
said surfactant being approximately 7.81% by weight of said solid material formula;
said iodine solution being approximately 0.87% by weight of said solid material formula;
said thickener being approximately 1.3% by weight of said solid material formula;
said hand soap being approximately 1.73% by weight of said solid material formula;
said defoamer being approximately 0.43% by weight of said solid material formula; and
said antimicrobial ingredient being approximately 0.13% by weight of said solid material formula.

18. The antimicrobial surface of claim 13 wherein said injection mold formula consisting of:
said copper flake being approximately 62.67% by weight of said solid material formula;
said epoxy resin being approximately 14.96% by weight of said injection mold formula;
said epoxy hardener being approximately 4.04% by weight of said injection mold formula;
said surfactant being approximately 14.14% by weight of said injection mold formula;
said iodine solution being approximately 0.8% by weight of said injection mold formula;
said thickener being approximately 1.21% by weight of said injection mold formula;
said hand soap being approximately 1.61% by weight of said injection mold formula;
said defoamer being approximately 0.4 by weight of said injection mold formula; and
said antimicrobial ingredient being approximately 0.12% by weight of said injection mold formula.

19. An object with a surface comprising:
an antimicrobial material added to said surface of said object;
said antimicrobial material comprising:
a metallic flake being between 45%-80% by weight of said antimicrobial material;
an epoxy resin being between 5%-30% by weight of said antimicrobial material;
an epoxy hardener being between 1%-10% by weight of said antimicrobial material; and
a surfactant being between 3%-25% by weight of said antimicrobial material.

20. A method of producing an antimicrobial material adapted to be added to the surface of an object comprising the steps of:
mixing together a first mixture with an epoxy resin and a first surfactant;
said epoxy resin being between 5%-30% by weight of said antimicrobial material; and
said surfactant being between 2%-15% by weight of said antimicrobial material.
mixing together a second mixture with an epoxy hardener, an iodine solution, and a second surfactant;
said epoxy hardener being between 1%-10% by weight of said antimicrobial material;
said iodine solution being between 0.5%-1% by weight of said antimicrobial material; and
said second surfactant being between 0-10% by weight of said antimicrobial material; and
mixing a metallic flake with said first and second mixtures;
said metallic flake being between 45%-80% by weight of said antimicrobial material.
